(19) United States
(12) Patent Application Publication
(10) Pub. No.: US 2004/0184387 A1
(43) Pub. Date: Sep. 23, 2004

(54) Photoreceptive amplifier circuit and optical pickup element including the same

(76) Inventors: Yasuyuki Shirasaka, Osaka (JP); Tomotake Kishida, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/764,532

(22) Filed: Jan. 27, 2004

(30) Foreign Application Priority Data
Jan. 28, 2003 (JP) 2003-019417

(51) Int. Cl. G11B 7/00

(52) U.S. Cl. 369/124.1

(57) ABSTRACT

An photoreceptive amplifier circuit includes a first differential amplifier having two input resistors, two input voltage dividing resistors, two feedback resistors, for providing temperature characteristic of sensitivity=0 of a photodiode with respect to light having wavelength of 650 nm, and a second differential amplifier having two input resistors, two input voltage dividing resistors, two feedback resistors for providing temperature characteristic of sensitivity=0 of a photodiode with respect to light having wavelength of 780 nm. One of outputs from these differential amplifiers is selected depending on the wavelength. Therefore, it is possible to cancel changes of the temperature characteristic due to variation of wavelength by the temperature characteristic of the sensitivity of the photoreceptive amplifier circuit so that the temperature characteristic of the whole optical pickup element becomes 0. Thus, such a photoreceptive amplifier circuit solves a problem of changes of temperature characteristics of sensitivity of a photodiode due to variation of wavelength, for a photoreceptive amplifier circuit which amplifies and outputs a signal from a photoreceptor on which optical signals of plural types of wavelength are supplied.

This Nonprovisional application claims priority under 35 U.S.C. § 119(a) on patent application Ser. No. 2003/019,417 filed in Japan on Jan. 28, 2003, the entire contents of which are hereby incorporated by reference.

### FIELD OF THE INVENTION

The present invention relates to a photoreceptive amplifier circuit for an optical pickup element, and an optical pickup element, which are used for a device capable of recording and/or reproduction of two-types of optical disks having different wavelength, such as a CD-R/RW and a DVD±R/RW, and in particular to a photoreceptive amplifier circuit used for a photoreceptor having a function of monitoring laser light intensity so as to control the laser light intensity to be a predetermined level.

### BACKGROUND OF THE INVENTION

There have been continuously formulated new standards of optical disks for different wavelengths, with the development of recording mediums and light sources; for example, 780 nm for the CD-R/RW, and 650 nm for DVD±R/RW. Under such circumstances, a recording and/or reproduction device compatible with plural types of disks has been widely used as a peripheral device of a personal computer. Further, in order to securely carry out reproduction and/or recording, such an optical device generally uses a method of detecting a part of laser beam emitting to a disk, and controls light intensity of the laser beam to be the optimal level, by monitoring the detection signal.

The device includes separate light sources for the respective wavelengths but uses the same photoreceptor, such as a photodiode, in terms of miniaturization of optical pickup elements or cost reduction. In this photoreceptor, the temperature characteristic of its sensitivity changes depending on wavelength.

For a general method of compensating the temperature characteristic, there has been known a method of providing resistances having different temperature characteristics to a photoreceptive amplifier circuit used for a laser power monitor. This arrangement is aimed at controlling the temperature characteristic of the sensitivity of the photoreceptive amplifier circuit so as to cancel the temperature characteristic of the photoreceptor. Then, upon recording and/or reproduction of optical disks, changes of the light intensity of the laser beam is constantly detected by a photoreceptor for a laser power monitor, and the photoreceptor then supplies output according to the result of detection, as a feedback to a light emitter of laser diode. With this manner, the light intensity of the laser beam can be kept in the optimal level.

However, this method cannot perform proper detection of laser beam intensity for the foregoing photoreceptor changing its temperature characteristic according to the wavelength, and the failure of detection may cause error particularly upon recording.

Here, as other reference of the method of monitoring laser beam, Japanese Laid-Open Patent Application Tokukai 2001-23218 (published on Jan. 21, 2001) discloses a technique for a laser beam whose wavelength changes depending on the temperature of light emitter, in which the laser light intensity is monitored for compensating temperature characteristic of the light emitter so that the laser beam intensity can be kept in the optimum level. Likewise, Japanese Laid-Open Patent Application Tokukai 2001-52368 (published on Feb. 23, 2001) discloses a technique in which the laser light intensity is monitored by a front monitor when the light intensity of laser beam is changed for switching writing and reading, thereby properly monitoring the light intensity of laser beam.

However, these conventional techniques are not helpful to compensate the temperature characteristic, which changes depending on the wavelength, of the photoreceptor.

### SUMMARY OF THE INVENTION

The present invention is made in view of the foregoing conventional problems, and an object is to provide a photoreceptive amplifier circuit for compensating temperature characteristic of the photoreceptor of the sensitivity, even when the temperature characteristic changes depending on the wavelength. The present invention also provides an optical pickup element including such a photoreceptive amplifier circuit.

In order to solve the foregoing problems, the photoreceptive amplifier circuit according to the present invention, for amplifying and outputting a signal from a photoreceptor on which optical signals of plural types of wavelength are supplied, includes: a former-stage amplifier for receiving the signal from the photoreceptor, a latter-stage amplifier for amplifying output of the first-stage amplifier, the former-stage amplifier including a feedback resistor and the latter-stage amplifier including resistors for determining sensitivity, the feedback resistor and at least a part of the resistors for determining sensitivity being made of different resistive elements having different temperature characteristics, the resistive elements varying depending on the types of wavelengths of the optical signals.

Accordingly, the photoreceptive amplifier circuit has a such a structure that the feedback resistor of the former-stage amplifier and at least a part of the resistors for determining sensitivity of the latter-stage amplifier are made of different resistive elements having different temperature characteristics, and also, the feedback resistors or amplifiers are selectively used in accordance with the type of wavelength of the optical signal. Such a photoreceptive amplifier circuit may be realized, for example, with a photoreceptive amplifier circuit for amplifying and outputting a signal from a photoreceptor on which optical signals of plural types of wavelength, such as a wavelength of 780 nm for a CD-R/RW dick, or a wavelength of 650 nm for DVD±R/RW disk, are incident, by providing the same number of feedback resistors (gain resistance) as that of types of wavelength in the former-stage amplifier to which the signal from the photoreceptor is supplied, and also providing the same number of amplifiers made up of resistors for determining sensitivity (such as input resistor or feedback resistors) as that of types of wavelength.

Therefore, by using resistive elements with appropriate temperature characteristics for the target wavelength to constitute the feedback resistor or the resistors for determining sensitivity, it is possible to cancel the temperature characteristic of the photoreceptor by the temperature characteristic of the sensitivity of the photoreceptive amplifier circuit, even when the temperature characteristic changes depending on the wavelength.

Further, an optical pickup element according to the present invention includes the foregoing photoreceptive amplifier circuit. Therefore, it is possible to cancel the temperature characteristic of the photoreceptor by the temperature characteristic of the sensitivity of the photoreceptive amplifier circuit, even when the temperature characteristic changes depending on the wavelength, thus securely realizing an optical pickup element free from influence of the temperature characteristics of sensitivity.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a drawing illustrating an optical system of a recording/reproduction device having an optical pickup element according to one embodiment of the present invention.

FIG. 2 is a block diagram illustrating an electrical arrangement of a photoreceptive amplifier circuit included in the optical pickup element according to one embodiment of the present invention, in the recording/reproduction device of FIG. 1.

FIG. 3 is an electric circuit diagram illustrating a concrete example of a differential amplifier in the optical pickup element (photoreceptive amplifier circuit) of FIG. 2.

FIG. 4 is a block diagram illustrating an electrical arrangement of the optical pickup element (photoreceptive amplifier circuit) according to another embodiment of the present invention.

FIG. 5 is an electric circuit diagram illustrating a concrete example of a differential amplifier of the optical pickup element (photoreceptive amplifier circuit) of FIG. 4.

FIG. 6 is a block diagram illustrating an electrical arrangement of an optical pickup element (photoreceptive amplifier circuit) according to still another embodiment of the present invention.

### DESCRIPTION OF THE EMBODIMENTS

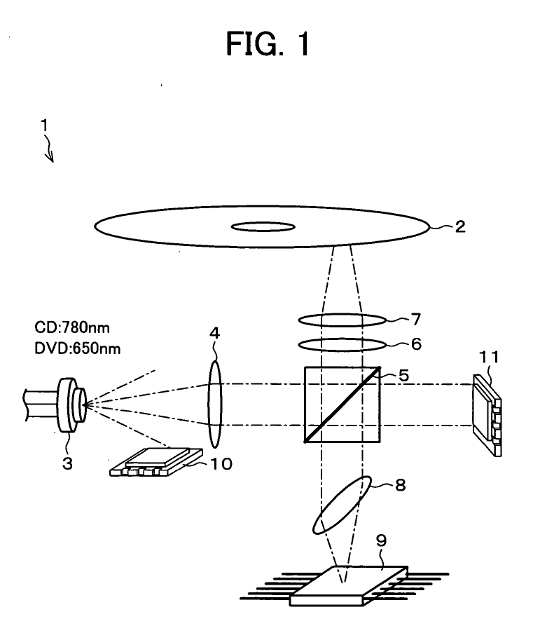

One embodiment of the present invention will be described below with reference to FIGS. 1 through 3.

FIG. 1 is a drawing illustrating an optical system of a recording/reproduction device 1 having a photoreceptive amplifier circuit according to one embodiment of the present invention. The recording/reproduction device 1 is capable of recording and/or reproduction of two-types of optical disks having different wavelengths, such as a CD-R/RW and a DVD±R/RW. The laser diode 3 as a light emitter emits a laser beam of 780 nm with respect to a CD-R/RW, and emits a laser beam of 650 nm with respect to a DVD±R/RW. The emitted laser beam is then converted into a parallel ray in a collimator lens 4, and the light path is warped by 90° at a beam splitter 5, before being incident on an optical disk 2 through a collimator lens 6 and an objective lens 7.

The reflection light of the optical disk 2 passes through the beam splitter 5 through the objective lens 7 and a collimator lens 6, and then is condensed onto a spot lens 8 before being incident in the photoreceptor 9. The photoreceptor 9 reproduces an information signal based on the incident optical signal, and also creates a signal for tracking or focusing servo so as to output the created signal to a signal processing circuit or a control circuit (both not shown). Upon recording, the light emitted from the laser diode 3 is modulated in accordance with the data to be written on the disk.

In such an optical system, a part of emitted light from the laser diode 3 travels to the beam splitter 5 and then to the optical pickup element 10 and 11. The optical element 10 is in the vicinity of the laser diode 3 on one side of the beam splitter 5, and the optical pickup element 11 is on the other side. These optical pickup elements 10 and 11 monitor the light and output the result as feedback to the laser diode 3, thus adjusting laser light intensity to be the optimal level.

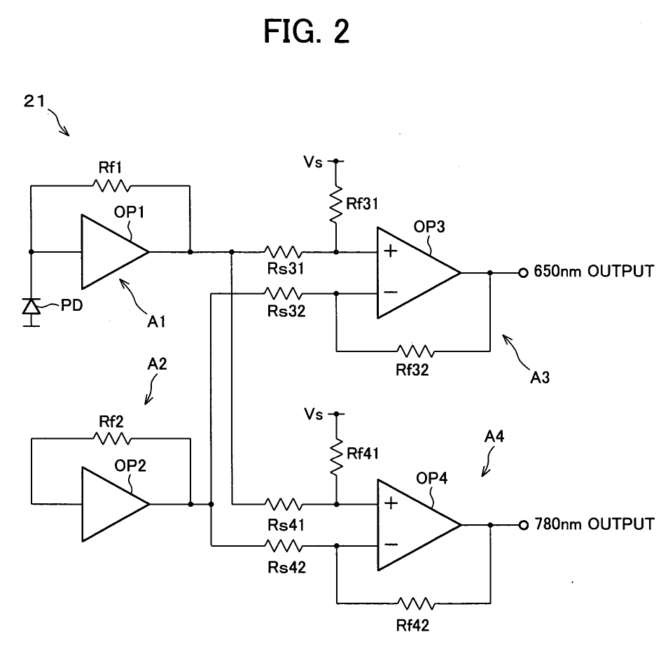

FIG. 2 is a block diagram illustrating an electrical arrangement of a photoreceptive amplifier circuit included in the optical pickup element 21 which is used for the foregoing optical pickup elements 10 and 11 according to one embodiment of the present invention. The optical pickup element 21 mainly includes a photodiode PD, amplifier A1 and A2, and differential amplifiers A3 and A4. The photodiode PD is a common photoreceptor for both a laser beam of 780 nm and a laser beam of 650 nm. The amplifier A1 as the first stage amplifier carries out conversion of a current signal supplied from the photodiode PD into a voltage signal. The amplifier A2 is another first stage amplifier provided for reference. The differential amplifiers A3 and A4 are the second stage amplifiers supplied with outputs of the amplifiers A1 and A2 so as to calculate the difference between A1 and A2.

The amplifier A1 includes an amplifier section OP1 and a feedback resistor (gain resistor) Rf1 which also performs current-voltage conversion of the current signal from the photodiode PD. The amplifier A2 as a reference amplifier is not connected to the photodiode PD, and includes, as with the amplifier A1, an amplifier section OP2 and a feedback resistor Rf2.

Meanwhile, the differential amplifier A3 as the second-stage amplifier for a DVD-type disk of 650 nm includes an amplifier section OP3, input resistors Rs31 and Rs32, an input voltage dividing resistor Rf31, and a feedback resistor Rf32. The output voltage of the amplifier A1 is divided with reference to the reference voltage Vs by the input resistor Rs31 and the input voltage dividing resistor Rf31 so as to be supplied to the positive input end of the amplifier section OP3. Further, the reference voltage from the amplifier A2 is supplied to the negative input end of the amplifier section OP3 via the input resistor Rs32. This negative input end is also supplied with feedback from the amplifier section OP3 via the feedback resistor Rf32. Accordingly, the differential amplifier A3 outputs an output voltage corresponding to optical input from the amplifier A1, and an output voltage corresponding to the difference between the optical input of the A1 and the reference voltage of the amplifier A2, which is not supplied with optical input, so that the amount equal to the voltage change due to optical input by the photodiode PD is amplified and outputted from the differential amplifier A3.

Similarly, the differential amplifier A4 as another second-stage amplifier for a CD-type disk of 780 nm includes an amplifier section OP4, input resistors Rs41 and Rs42, an input voltage dividing resistor Rf41, and a feedback resistor Rf42. The output voltage of the amplifier A1 is divided with reference to the reference voltage Vs by the input resistor Rs41 and the input voltage dividing resistor Rf41 so as to be supplied to the positive input end of the amplifier section OP4. Further, the reference voltage from the amplifier A2 is supplied to the negative input end of the amplifier section OP4 via the input resistor Rs42. This negative input end is also supplied with feedback from the amplifier section OP4 via the feedback resistor Rf42.

In the optical pickup element 21 having such an arrangement, the feedback resistor Rf1 of the amplifier A1 as the first-stage amplifier and the feedback resistor Rf2 of the amplifier A2 as a reference amplifier have the same temperature characteristic (sheet resistance value) and the same resistance value by a diffused resistor (resistive element) or the like. The differential amplifiers A3 and A4 have the resistor Rf31, Rf32 and Rf41, Rf42, respectively.

Here, assuming that Rf31=Rf32=Rf3, Rf41=Rf42=Rf4, Rs31=Rs32=Rs3, Rs41=Rs42=Rs4, a sensitivity S [V/W] of the photoreceptive amplifier circuit is given by the following formula,

$$S = η \times Rf1 \times \frac{Rf3 ( 4 )}{Rs3 ( 4 )}$$

where a conversion efficiency of the photodiode is expressed as η [A/W]. However, it should be noted that the subscription 3(4) is used only for respective outputs from the differential amplifier A3 and A4.

The partial differential of the sensitivity S ([V/W]) to the temperature T (° C.) is given by the following formula.

$$\begin{matrix}\frac{\partial S}{\partial T} = \frac{\partial η}{\partial T} \times Rf1 \times \frac{Rf3 ( 4 )}{Rs3 ( 4 )} + η \times \frac{\partial Rf1}{\partial T} \times \frac{Rf3 ( 4 )}{Rs3 ( 4 )} + \\ η \times Rf1 \times ( \frac{\partial Rf3 ( 4 )}{\partial T} \times \frac{1}{Rs3 ( 4 )} - \frac{Rf3 ( 4 )}{{Rs3 ( 4 )}^{2}} \times \frac{\partial Rs3 ( 4 )}{\partial T} )\end{matrix}$$

Further, the differential temperature coefficient (∂S/∂T)/S of the sensitivity is given by the following formula.

$$\frac{\partial S}{\partial T} / S = \frac{\partial η / \partial T}{η} + \frac{\partial Rf1 / \partial T}{Rf1} + \frac{\partial Rf3 ( 4 ) / \partial T}{Rf3 ( 4 )} - \frac{\partial Rs3 ( 4 ) / \partial T}{Rs3 ( 4 )}$$

Accordingly, the temperature coefficient of the sensitivity S is given by the following formula.

(temperature coefficient of S) [ppm/° C.]=(temperature coefficient of η)+(temperature coefficient of Rf1)+(temperature coefficient of Rf3(4))−(temperature coefficient of Rs3(4))

More specifically, the resistors Rf1 and Rf2, the resistors Rf31 and Rf32 and the resistors Rf41 and Rf42 have a temperature characteristic functioning to the same polarity as that of the photodiode PD, and the input resistors Rs31 and Rs32 and the input resistors Rs41 and Rs42 have a temperature characteristic functioning to the opposite polarity of that of the photodiode PD. Though it depends on the process, the temperature coefficient of the conversion efficiency η of the photodiode PD is 200[ppm/° C.] with respect to the incident light with a wavelength of 650 nm, and is 2000[ppm/° C.] with respect to the incident light with a wavelength of 780 nm.

Accordingly, the feedback resistor Rf1 is formed from a diffused resistor with a temperature coefficient of 500[ppm/° C.], and the resistors Rf3 and Rs3 are formed from diffused resistors with the temperature coefficients of 500[ppm/° C.] and 1200[ppm/° C.], for example. With this arrangement, it is possible to provide a temperature characteristic=0 for the sensitivity of the output from the differential amplifier A4 for a DVD-type disk with a wavelength of 650 nm, as denoted by the formula below.

(temperature coefficient of S) [ppm/° C.]=200+500+500−1200=0

Further, the resistors Rf4 and Rs4 are formed from diffused resistors with the temperature coefficients of 500[ppm/° C.] and 3000[ppm/° C.], for example. With this arrangement, it is possible to provide a temperature characteristic=0 for the sensitivity of the output from the differential amplifier A4 for a CD-type disk with a wavelength of 780 nm, as denoted by the formula below.

(temperature coefficient of S) [ppm/° C.]=2000+500 +500−3000=0

With such a manner, it is possible to provide a temperature characteristic=0 for the output from the photoreceptive amplifier circuit, regardless of the wavelength of incident light.

Meanwhile, a polysilicon resistor originally has a negative temperature characteristic. Thus, a combination of a polysilicon transistor and a diffused resistor can also realize a photoreceptive amplifier circuit with a temperature characteristic=0 for the sensitivity, regardless of the wavelength.

For example, with respect to a wavelength of 650 nm, the feedback resistor Rf1 is formed from a diffused resistor with a temperature coefficient of 500[ppm/° C.], and the resistor Rf3 is formed from a polysilicon resistor with temperature coefficient of −350[ppm/° C.], and further, the input resistor Rs3 is formed from a diffused resistor with a temperature coefficient of 350[ppm/° C.], for example. With this arrangement, it is possible to provide a temperature characteristic=0 for the sensitivity, as denoted by the formula below.

(temperature coefficient of S) [ppm/° C.]=200+500+(−350)−350=0

Further, with respect to a wavelength of 780 nm, the resistor Rf4 is formed from a polysilicon resistor with a temperature coefficient of −2000[ppm/° C.], and the input resistor Rs4 is formed from a diffused resistor with a temperature coefficient of 500[ppm/° C.), for example. With this arrangement, it is possible to provide a temperature characteristic=0 for the sensitivity, as denoted by the formula below.

(temperature coefficient of S) [ppm/° C.]=2000+500+(−2000)−500=0

Furthermore, such a photoreceptive amplifier circuit with a temperature characteristic=0 can be formed only from plural polysilicon resistors which differ to each other in temperature coefficient, without using diffused resistors.

For example, with respect to a wavelength of 650 nm, the resistors Rf1 and Rf3 are formed from a polysilicon resistor with a temperature coefficient of −500[ppm/° C.], respectively, and the input resistor Rf3 is formed from a polysilicon resistor with a temperature coefficient of −800[ppm/° C.). With this arrangement, it is possible to provide a temperature characteristic=0 for the sensitivity, as denoted by the formula below.

(temperature coefficient of S) [ppm/° C.]=200 +(−500)+(−500)−(−800)=0

For example, with respect to a wavelength of 780 nm, the resistors Rf4 is formed from a polysilicon resistor with a temperature coefficient of −2000[ppm/° C.], and the input resistor Rf4 is formed from a polysilicon resistor with a temperature coefficient of −500[ppm/° C.). With this arrangement, it is possible to provide a temperature characteristic=0 for the sensitivity, as denoted by the formula below.

(temperature coefficient of S) [ppm/° C.]=2000+(−500)+(−2000)−(−500)=0

As described, it is possible to provide a temperature characteristic=0 for the sensitivity, even when the wavelength of incident light changes. This allows accurate detection of laser light intensity at all times, thus ensuring secure recording and/or reproduction of an optical dick 2 with plural laser wavelengths.

Further, with the optical pickup elements 10 and 11 made up of the foregoing photoreceptive amplifier circuit offering a temperature characteristic of 0 for the output of a photoreceptor used as a laser power monitor, it is possible to carry out monitoring for laser power of two wavelengths, with a single chip.

Furthermore, foregoing arrangement is provided in the first stage with another amplifier A2 as a reference of the photodiode PD; and the differential amplifiers A3 and A4 are supplied with outputs from the first stage amplifiers A1 and A2 which are supplied with signals from the photodiode PD, so as to calculate the deference between A1 and A2. With this arrangement, it is possible to obtain only a voltage amount corresponding to the change due to optical input from the photodiode PD, the voltage amount being amplified before outputted.

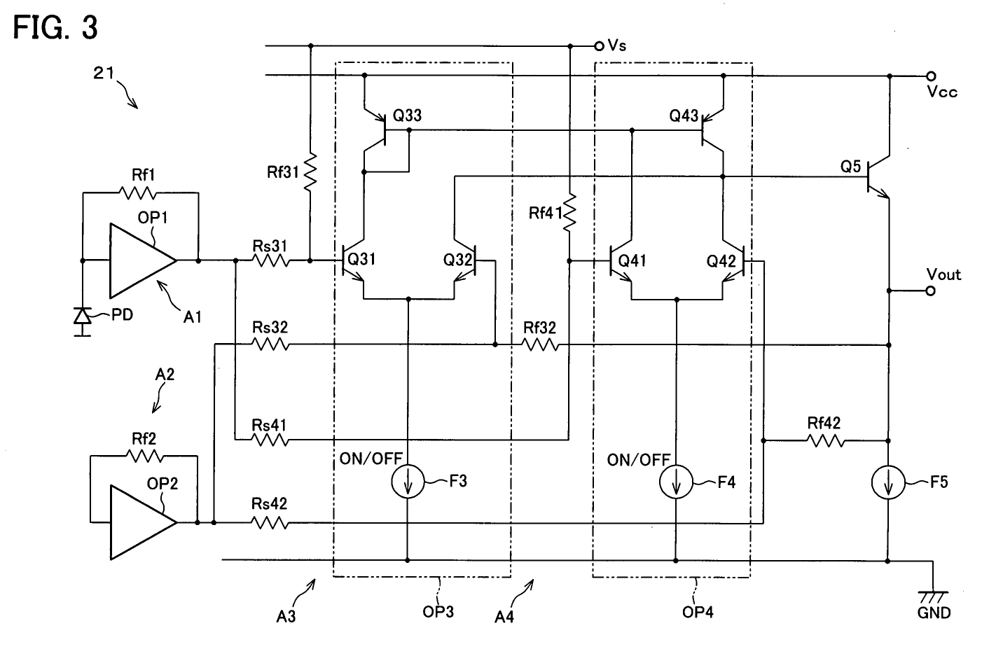

FIG. 3 is an electric circuit diagram of a photoreceptive amplifier circuit in the optical pickup element 21, illustrating a concrete example of differential amplifiers A3 and A4. In FIG. 3, for ease of explanation, materials having the equivalent functions as those shown in the drawings pertaining to the foregoing embodiment will be given the same reference symbols, and explanation thereof will be omitted here. As a noticeable feature of this optical pickup element 21, the outputs from the differential amplifiers A3 and A4 are joined together. More specifically, the differential amplifier A3 includes a differential pair made up of NPN-type transistors Q31 and Q32. The respective emitters of these transistors are connected to each other, before grounded via a constant-current source F3.

The base of the transistor Q31 operates as the positive input terminal of the differential amplifier A3 shown in FIG. 2, and is connected to the output terminal of the first stage amplifier A1 via an input resistor Rs31, and also is supplied with the reference voltage Vs via the input voltage dividing resistor Rf31. Further, the base of the transistor Q32 operates as the negative input terminal of the differential amplifier A3 shown in FIG. 2, and is connected to the output terminal of the reference amplifier A2 via an input resistor Rs32, and also is supplied with a an output Vout as a feedback voltage, via the feedback resistor Rf32.

Likewise, the differential amplifier A4 includes a differential pair made up of NPN-type transistors Q41 and Q42. The respective emitters of these transistors are connected to each other, before grounded via a constant-current source F4. The base of the transistor Q41 operates as the positive input terminal of the differential amplifier A4 shown in FIG. 2, and is connected to the output terminal of the first stage amplifier A1 via an input resistor Rs41, and also is supplied with the reference voltage Vs via the input voltage dividing resistor Rf41. Further, the base of the transistor Q42 operates as the negative input terminal of the differential amplifier A4 shown in FIG. 2, and is connected to the output terminal of the reference amplifier A2 via an input resistor Rs42, and also is supplied with an output Vout as a feedback voltage, via the feedback resistor Rf42.

Meanwhile, the collector of the transistor Q31 is supplied with a power source voltage Vcc via the PNP transistor Q33 as an active load. Similarly, the collector of the transistor Q42 is supplied with a power source voltage Vcc via the PNP transistor Q43 as an active load. These transistors Q33 and Q43 constitute a current mirror circuit, and the base of the transistor Q33 is connected to the collector of the transistor Q31 for constituting a diode structure. Further, the collector of the transistor Q33 is connected to the collectors of the transistors 31 and 41 corresponding to positive input. The collector of the transistor Q43 is connected to the collectors of the transistors Q32 and Q42 corresponding to negative input.

Furthermore, each collector of the transistors Q32, Q42 and Q43 is connected to the base of the NPN-type transistor Q5. The collector of the NPN-type transistor Q5 is supplied with a power source voltage Vcc, and the emitter is grounded via the constant-current source F5. The transistor Q5 and the constant-current source F5 constitute an emitter follower circuit. The emitter of the transistor Q5 as an output end is connected to the output terminal, and also is connected to the transistors Q32 and Q42 corresponding to negative input via the feedback resistors Rf32 and Rf42.

Then, by selectively supplying a bias voltage to the constant-current circuits F3 and F4 according to the wavelength, it is possible to selectively use one of the differential amplifiers A3 and A4, thus appropriately compensate the foregoing temperature characteristic of the photodiode PD. With this manner, the respective output terminals of the second-stage differential amplifiers A3 and A4 are unified, thus reducing the chip size of the optical pickup elements 10 and 11, and also reducing cost. Also, in this structure, output signals for a plurality of laser wavelengths is outputted from the laser power monitoring photoreceptor via one output terminal. Therefore, it offers easier signal processing in the second-stage integrated circuits for driving the laser diode 3, while realizing cost reduction.

Note that, in the foregoing example, the relations between the respective resistors are set as Rf31=Rf32=Rf3, Rf41=Rf42=Rf4, Rs31=Rs32=Rs3, and Rs41=Rs42=Rs4, i.e., the resistance values and temperature characteristics of those resistors are unified; however, the respective resistors may have different values. The equal resistance value and the equal temperature characteristic however simplify the formula for the sensitivity, as with the formula 1. Further, with the relations, it is possible to equalize voltages generated in the respective resistors Rf3, Rf4, Rs3, and Rf4 by the input currents (a base current supplied to the differential pairs Q31 and Q32; Q41 and Q42, refer to FIG. 3) regardless of the temperature, thus compensating the offset voltage.

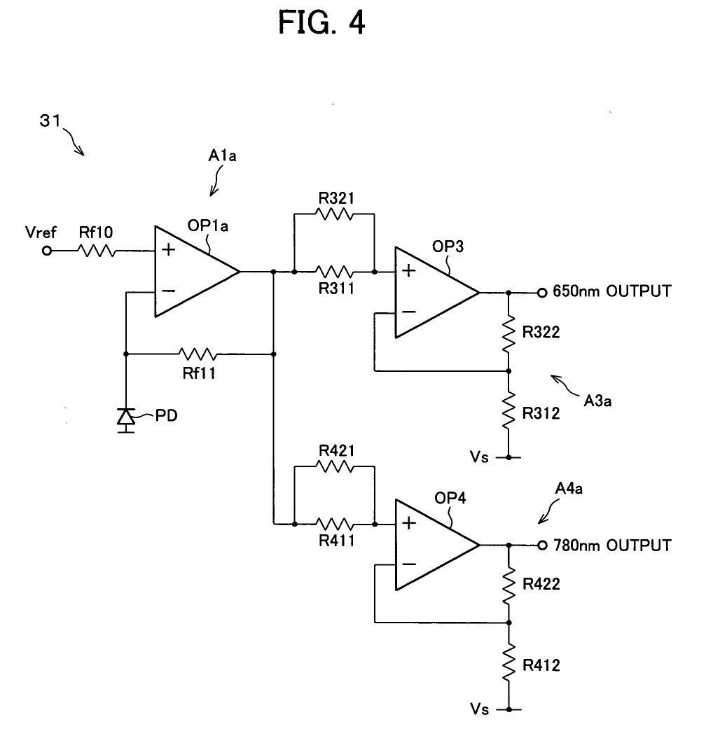

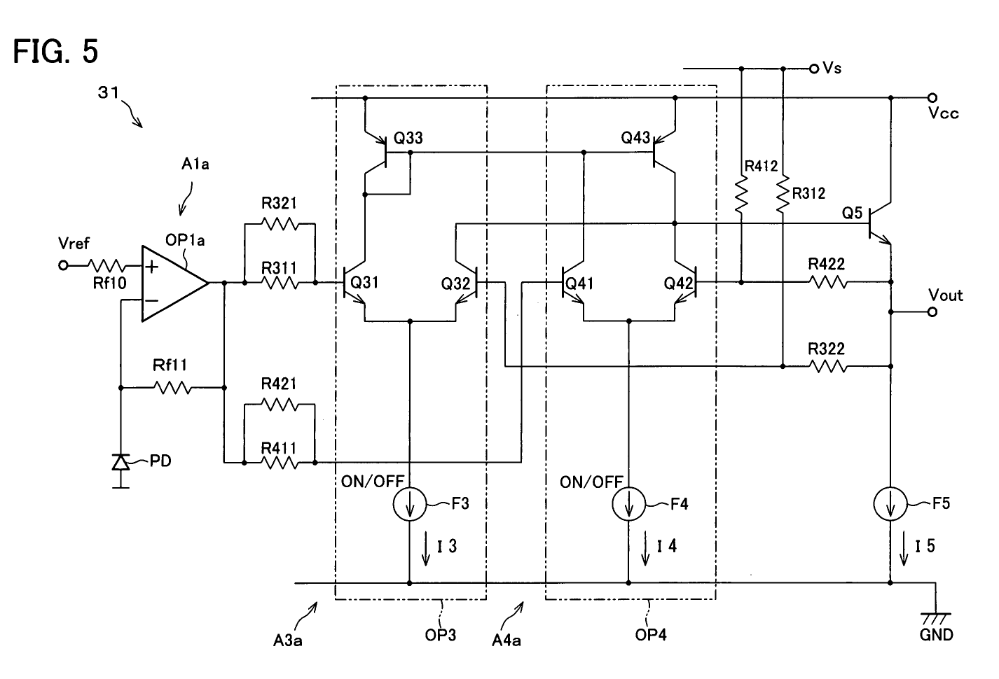

Another embodiment of the present invention is described below with reference to FIGS. 4 and 5.

FIG. 4 is a block diagram illustrating an electrical arrangement of a photoreceptive amplifier circuit in the optical pickup element 31 according to another embodiment of the present invention. The optical pickup element 31 is similar to the optical pickup element 21 above. Therefore, for ease of explanation, materials having the equivalent functions as those shown in the drawings pertaining to the foregoing embodiment will be given the same reference symbols, and explanation thereof will be omitted here.

This pickup element 31 includes at the first-stage a differential amplifier A1a including an amplifier section OP1a, an input resistor Rf10 and a feedback resistor (gain resistor) Rf11. The positive input terminal of the amplifier section OP1a is supplied with reference voltage Vref via the input resistor Rf10, and the negative input terminal is supplied with a current signal from the photodiode PD, as well as feedback from the amplifier section OP1a via the feedback resistor Rf11. The feedback resistor also performs current-voltage conversion. The input resistor Rf10 for offset voltage compensation is provided in the same form as the feedback voltage Rf11.

Meanwhile, the differential amplifier A3a as a second-stage amplifier for a DVD-type disk of 650 nm includes an amplifier section OP3, input resistors R311 and R321, which are used for offset voltage compensation, and output dividing resistors R312 and R322. The output voltage of the first-stage amplifier A1a is supplied to the positive input terminal of the amplifier section OP3 via the input resistors R311 and R321 connected in series to each other. The output dividing resistors R312 and R322 divide the output of the amplifier section OP3 with reference to the reference voltage Vs, so as to supply the divided voltage to the negative input terminal of the amplifier section OP3.

Similarly, the differential amplifier A4a as another second-stage amplifier for a CD-type disk of 780 nm includes an amplifier section OP4, input resistors R411 and R421, which are used for offset voltage compensation, and output dividing resistors R412 and R422. The output voltage of the first-stage amplifier A1a is supplied to the positive input terminal of the amplifier section OP4 via the input resistors R411 and R421 connected in series to each other. The output dividing resistors R412 and R422 divide the output of the amplifier section OP4 with reference to the reference voltage Vs of high level, so as to supply the divided voltage to the negative input terminal of the amplifier section OP4.

When it is assumed that R311=R312=R31, R321=R322=R32, R411=R412=R41 and R421=R422=R42 in a photoreceptive amplifier circuit having foregoing arrangement, a sensitivity S [V/W] of the photoreceptive amplifier circuit is given by the following formula,

$$S = η \times Rf11 \times ( 1 + \frac{R32 ( 42 )}{R31 ( 41 )} )$$

where a conversion efficiency of the photodiode is expressed as η [A/W]. However, it should be noted that the subscription 31, 32(41, 42) is used only for respective outputs from the differential amplifier A3 and A4.

Therefore, the differential temperature coefficient (∂S/∂T)/S of the sensitivity is given by the following formula.

$$\begin{matrix}\frac{\partial R}{\partial T} / S = \frac{\partial η / \partial T}{η} + \frac{\partial Rf11 / \partial T}{Rf11} + \frac{R32 ( 42 )}{R31 ( 41 ) + R32 ( 42 )} \times \\ ( \frac{\partial R32 ( 42 ) / \partial T}{R32 ( 42 )} - \frac{\partial R31 ( 41 ) / \partial T}{R31 ( 41 )} )\end{matrix}$$

Accordingly, the temperature coefficient of the sensitivity S is given by the following formula.

(temperature coefficient of S) [ppm/° C.]=(temperature coefficient of η)+(temperature coefficient of Rf11)+{(temperature coefficient of R32(42))−(temperature coefficient of R31(41))}×R32(42)/{R31(41)+R32(42)}

Accordingly, by setting the respective temperature coefficients of the resistors R31 and R32; R41 and R42 according to the temperature coefficient of the conversion efficiency η of the photodiode PD, it is possible to provide a temperature characteristic=0 for the sensitivity S, with respect to both a wavelength of 650 nm and a wavelength of 780 nm.

For example, as with the photoreceptive amplifier circuit, when the temperature coefficient of the conversion efficiency η of the photodiode PD is 200[ppm/° C.] for a wavelength of 650 nm, and 2000[ppm/° C.] for a wavelength of 780 m, the feedback resistor Rf11 and the resistor R32 are each formed from a diffused resistor with a temperature from a diffused resistor with the temperature coefficient of 1900[ppm/° C.]. Further, the same resistance value is provided to the resistors R31 and R32. With this arrangement, it is possible to provide a temperature characteristic=0 for the sensitivity of the output from the differential amplifier A3a for a DVD-type disk with a wavelength of 650 nm, as denoted by the formula below.

(temperature coefficient of S) [ppm/° C.]=200+500+R32/(R31+R32)×(500−1900)=0

Further, with respect to a wavelength of 780 nm, the resistors Rf11 and the resistor R42 are each formed from a diffused resistor with a temperature coefficient of 500[ppm/° C.], and the resistor R41 is formed from a diffused resistor with a temperature coefficient of 3500[ppm/° C.), and the resistors R41 and R42 are provided with resistance values of 1[kΩ] and 5[kΩ], respectively. With this arrangement, it is possible to provide a temperature characteristic=0 for the sensitivity of the output from the differential amplifier A4a for a CD-type disk with a wavelength of 780 nm, as denoted by the formula below.

(temperature coefficient of S) [ppm/° C.]=2000+500 +5/(1+5)×(500−3500)=0

Further, a combination of a polysilicon transistor and a diffused resistor can also realize a photoreceptive amplifier circuit with a temperature characteristic=0 for the sensitivity, regardless of the wavelength. For example, with respect to a wavelength of 650 nm, the feedback resistor Rf11 is formed from a polysilicon resistor with a temperature coefficient of −1000[ppm/° C.], the resistor R31 is formed from a polysilicon resistor with temperature coefficient of −800[ppm/° C.], and the resistor R32 is formed from a diffused resistor with a temperature coefficient of 800[ppm/° C.], for example. Further, the same resistance value is provided to the resistors R31 and R32. With this arrangement, it is possible to provide a temperature characteristic=0 for the sensitivity of the output from the differential amplifier A3a for a DVD-type disk with a wavelength of 650 nm, as denoted by the formula below.

(temperature coefficient of S) [ppm/° C.]=200+(−1000)+R32/(R31+R32)×{800−(−800)}=0

Further, with respect to a wavelength of 780 nm, the feedback resistor Rf11 is formed from a polysilicon resistor with a temperature coefficient of −1000[ppm/° C.], the resistor R41 is formed from a diffused resistor with a temperature coefficient of 500[ppm/° C.), and the resistor R42 is formed from a polysilicon resistor with a temperature coefficient of −1500[ppm/° C.), for example. Further, the same resistance value is provided to the resistors R41 and R42. With this arrangement, it is possible to provide a temperature characteristic=0 for the sensitivity of the output from the differential amplifier A4a for a CD-type disk with a wavelength of 780 nm, as denoted by the formula below.

(temperature coefficient of S) [ppm/° C.]=2000+(−1000)+R42/(R41+R42)×{(−1500)−500}=0

Furthermore, such a photoreceptive amplifier circuit with a temperature characteristic=0 can be formed only from plural polysilicon resistors which differ to each other in temperature coefficient, without using diffused resistors.

For example, with respect to a wavelength of 650 nm, the feedback resistors Rf11 is formed from a polysilicon resistor with a temperature coefficient of −1000[ppm/° C.], and the resistors R31 and R32 are formed from polysilicon resistors with temperature coefficients of −2100[ppm/° C.) and −500[ppm/° C.), respectively. Further, the same resistance value is provided to the resistors R31 and R32. With this arrangement, it is possible to provide a temperature characteristic=0 for the sensitivity of the output from the differential amplifier A3a for a DVD-type disk with a wavelength of 650 nm, as denoted by the formula below.

(temperature coefficient of S) [ppm/° C.]=200+(−1000)+R32/(R31+R32)×{−500−(−2100)}=0

Further, with respect to a wavelength of 780 nm, the feedback resistor Rf11 is formed from a polysilicon resistor with a temperature coefficient of −1000[ppm/° C.], and the resistors R41 and R42 are formed from polysilicon resistors with a temperature coefficient of −500[ppm/° C.) and a temperature coefficient of −2000[ppm/° C.), respectively. Further, the resistors R41 and R42 are provided with resistance values of 1[kΩ] and 2[kΩ], respectively. With this arrangement, it is possible to provide a temperature characteristic=0 for the sensitivity of the output from the differential amplifier A4a for a CD-type disk with a wavelength of 780 nm, as denoted by the formula below.

(temperature coefficient of S) [ppm/° C.]=2000+(−1000)+2/(1+2)×{−2000−(−500)}=0

FIG. 5 is an electric circuit diagram of a photoreceptive amplifier circuit in the optical pickup element 31, illustrating a concrete example of differential amplifiers A3a and A4a. In FIG. 5, for ease of explanation, materials having the equivalent functions as those shown in the drawings pertaining to the foregoing embodiment will be given the same reference symbols, and explanation thereof will be omitted here. In this optical pickup element 31, the two differential amplifiers A3a and A4a have the amplifier sections OP3 and OP4, which are the same as those of the differential amplifiers A3 and A4 above, i.e., the outputs of the differential amplifiers A3a and A4a are joined together.

The base of the transistor Q31 operates as the positive input terminal of the differential amplifier A3a shown in FIG. 4, and is connected to the output terminal of the first stage amplifier A1a via input resistors R311 and R321, which are used for offset voltage compensation. Meanwhile, the base of the transistor Q32 operates as the negative input terminal of the differential amplifier A3a shown in FIG. 4, and is supplied with the reference voltage Vs via the output dividing resistor R312, and also is supplied with an output Vout as a feedback voltage, via the output dividing resistor R322.

Likewise, The base of the transistor Q41 operates as the positive input terminal of the differential amplifier A4a shown in FIG. 4, and is connected to the output terminal of the first stage amplifier A1a via input resistors R411 and R421, which are used for offset voltage compensation. Meanwhile, the base of the transistor Q42 operates as the negative input terminal of the differential amplifier A4a shown in FIG. 4, and is supplied with the reference voltage Vs via the output dividing resistor R412, and also is supplied with an output Vout as a feedback voltage, via the output dividing resistor R422.

Then, by selectively supplying a bias voltage to the constant-current circuits F3 and F4 according to the wavelength, it is possible to selectively use one of the differential amplifiers A3a and A4a even when only one output terminal is used, thus appropriately compensate the foregoing temperature characteristic of the photodiode PD. With this manner, the respective output terminals of the second-stage differential amplifiers A3 and A4 are unified.

Note that, the temperature characteristic of the differential amplifiers A3a and A4a depend on the dividing resistors R312 and R322; R412 and R422, and the input resistors R311 and R321; R411 and R421 have no relation with the temperature characteristics of A3a and A4a, and therefore, the temperature characteristics of those input resistors can be any values. However, in the foregoing example, the relations between the respective resistors are set as R311=R312=R31, R321=R322=R32, R411=R412=R41, and R4211=R422=R42, i.e., the resistance values and temperature characteristics of those resistors are unified. With the equal resistance value and the equal temperature characteristic, it is possible to, as with the foregoing differential amplifiers A3 and A4, equalize voltages generated in the respective resistors R31 and R32; R41 and R42 by the input currents regardless of the temperature, thus compensating the offset voltage.

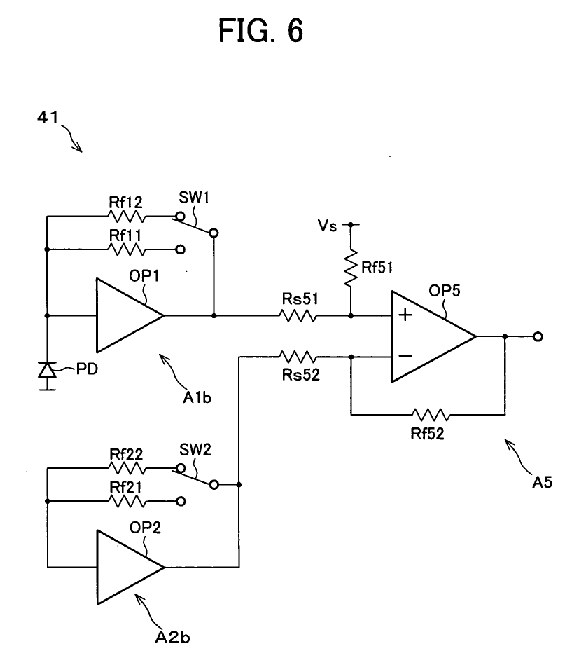

Still another embodiment of the present invention will be described below with reference to FIG. 6.

FIG. 6 is a block diagram illustrating an electrical arrangement of a photoreceptive amplifier circuit included in the optical pickup element 41 according to still another embodiment of the present invention. The optical pickup element 41 is similar to the optical pickup element 21 above. Therefore, for ease of explanation, materials having the equivalent functions as those shown in the drawings pertaining to the foregoing embodiment will be given the same reference symbols, and explanation thereof will be omitted here. As one noticeable feature, this optical pickup element 41 mainly includes at the first stage an amplifier A1b for converting a current signal from a photodiode PD into a voltage signal, and an amplifier A2b which is used for reference. At the second stage, the optical pickup element 41 includes a single differential amplifier A5 for calculating the difference between A1b and A2b.

The amplifier A1b includes an amplifier section OP1, two feedback resistors (gain resistor) Rf11 and Rf12, and a switching element SW1 for selecting one of the feedback resisters Rf11 and Rf12. Similarly, the amplifier A2b includes an amplifier section OP2, and two feedback resistors (gain resistor) Rf21 and Rf22, and a switching element SW2 for selecting one of the feedback resisters Rf21 and Rf22.

The differential amplifier A5 includes an amplifier section OP5, two input resistors Rs51 and Rs52, an input voltage dividing resistor Rf51, and a feedback resistor Rf52. The output voltage of the amplifier A1b is divided with reference to the reference voltage Vs by the input resistor Rs51 and the input voltage dividing resistor Rf51 so as to be supplied to the positive input terminal of the amplifier section OP5. Further, the reference voltage from the amplifier A2b is supplied to the negative input terminal of the amplifier section OP5 via the input resistor Rs52. This negative input terminal is also supplied with feedback from the amplifier section OP5 via the feedback resistor Rf52.

In the optical pickup element 41 having such an arrangement, the feedback resistors Rf11 and Rf12, and the feedback resistors Rf21, and Rf21 are formed with the same temperature characteristic (sheet resistance value) and the same resistance value by using a diffused resistor or the like. When it is assumed that Rf51=Rf52=Rf5, Rs51=Rs52=Rs5, a sensitivity S [V/W] of the photoreceptive amplifier circuit is given by the following formula,

$$S = η \times ( Rf11 or Rf12 ) \times \frac{Rf5}{Rs5}$$

where a conversion efficiency of the photodiode PD is expressed as η [A/W]. However, it should be noted that (Rf11 or Rf12) in the formula refers to that only one of the RF11 and Rf12 is selected by the switching SW1 and SW2.

Further, the temperature coefficient (∂S/∂T)/S of the sensitivity is given by the following formula.

$$\begin{matrix}\frac{\partial R}{\partial T} / S = \frac{\partial η / \partial T}{η} + ( \frac{\partial Rf11 / \partial T}{Rf11} or \frac{\partial Rf12 / \partial T}{Rf12} ) + \\ \frac{\partial Rf5 / \partial T}{Rf5} - \frac{\partial Rs5 / \partial T}{Rs5}\end{matrix}$$

Accordingly, the temperature coefficient of the sensitivity S is given by the following formula.

(temperature coefficient of S) [ppm/° C.]=(temperature coefficient of η)+(temperature coefficients of Rf11 and Rf12)+(temperature coefficient of Rf5)−(temperature coefficient of Rs5)

More specifically, the feedback resistors Rf11 and Rf12, and the feedback resistor Rf5 have temperature characteristics functioning to the same polarity as that of the photodiode PD, and the input resistors Rs5 has a temperature characteristic functioning to the opposite polarity of that of the photodiode PD.

Thus, when it is assumed that the temperature coefficient of the conversion efficiency η of the photodiode PD is 200[ppm/° C.] with respect to the incident light with a wavelength of 650 nm, and is 2000[ppm/° C.] with respect to the incident light with a wavelength of 780 nm for example; the feedback resistor Rf5 and Rs5 are formed from diffused resistors with the temperature coefficients of 500[ppm/° C.] and 3000[ppm/° C.], respectively. Further, the feedback resistors Rf11 and Rf12 are formed from diffused resistors with the temperature coefficients of 2300[ppm/° C.] and 500[ppm/° C.], respectively. With this arrangement, it is possible to provide a temperature characteristic=0 for the sensitivity as denoted by the formula below, by selecting the feedback resistor Rf11 for output of a DVD-type disk with a wavelength of 650 nm.

(temperature coefficient of S) [ppm/° C.]=200+2300+500−3000=0

Further, by selecting the feedback resistor Rf12 for a CD-type disk with a wavelength of 780 nm, it is possible to provide a temperature characteristic=0 for the sensitivity, as denoted by the formula below.

(temperature coefficient of S) [ppm/° C.]=2000+500+500−3000=0

With such a manner, by selecting one of the feedback resistors Rf11 and Rf12, it is possible to provide a temperature characteristic=0 for the output of the photoreceptive amplifier circuit 41 regardless of the wavelength.

Further, as described, a combination of a polysilicon transistor having a negative temperature coefficient and a diffused resistor can also offer a temperature characteristic=0 for the whole of the optical pickup element. For example, with respect to a wavelength of 650 nm, the feedback resistors Rf51 and Rs51 are formed from diffused resistors with a temperature coefficient of 500[ppm/° C.] and 1000[ppm/° C.], respectively; and the resistor Rf11 is formed from a diffused resistor with temperature coefficient of 300[ppm/° C.]. With this arrangement, it is possible to provide a temperature characteristic=0 for the sensitivity, as denoted by the formula below.

(temperature coefficient of S) [ppm/° C.]=200+300+500−1000=0

Further, with respect to a wavelength of 780 nm, the feedback resistor Rf12 is formed from a polysilicon resistor with a temperature coefficient of −1500[ppm/° C.], for example. With this arrangement, it is possible to provide a temperature characteristic=0 for the sensitivity, as denoted by the formula below.

(temperature coefficient of S) [ppm/° C.]=2000+(−1500)+500−1000=0

Furthermore, such a photoreceptive amplifier circuit with a temperature characteristic=0 can be formed only from plural polysilicon resistors which differ to each other in temperature coefficient, without using diffused resistors. For example, with respect to a wavelength of 650 nm, the resistors Rf51 and Rs51 are formed from polysilicon resistors with a temperature coefficient of −500[ppm/° C.] and −1000[ppm/° C.], respectively; and the feedback resistor Rf11 is formed from a polysilicon resistor with a temperature coefficient of −700[ppm/° C). With this arrangement, it is possible to provide a temperature characteristic=0 for the sensitivity, as denoted by the formula below.

(temperature coefficient of S) [ppm/° C.]=200+(−700)+(−500)−(−1000)=0

Further, with respect to a wavelength of 780 nm, the feedback resistor Rf12 is formed from a polysilicon resistor with a temperature coefficient of −2500[ppm/° C.]. With this arrangement, it is possible to provide a temperature characteristic=0 for the sensitivity, as denoted by the formula below.

(temperature coefficient of S) [ppm/° C.]=2000+(−2500)+(−2000)+(−500)−(−1000)=0

In the foregoing example, the optical pickup elements have two-stage structures with the first-stage amplifiers A1 and A2; A1a; and A1b and A2b, and the second-stage differential amplifiers A3 and A4; A3a and A4a; and A5. However, the present invention also allows the use of three or larger stages amplifiers so as to obtain a desired sensitivity or to obtain output of a desired polarity (so as to allow selection between positive output whose voltage increases with an increase of incident light amount to the photodiode PD, and negative output whose voltage decreases with the increase of incident light amount).

As described, the photoreceptive amplifier circuit according to the present embodiment, for amplifying and outputting a signal from a photoreceptor on which optical signals of plural types of wavelength are supplied, is arranged so that the feedback resistor of the first-stage amplifier supplied with a signal from the photoreceptor and at least a part of the resistors for determining sensitivity of the later-stage amplifiers are made of different resistive elements having different temperature characteristics, the resistive elements being selectively used in accordance with the types of wavelengths of the optical signals.

More specifically, the photoreceptive amplifier circuit has a such a structure that the feedback resistor of the former-stage amplifier and at least a part of the resistors for determining sensitivity of the latter-stage amplifier are made of different resistive elements having different temperature characteristics, and also, the feedback resistors or amplifiers are selectively used in accordance with the type of wavelength of the optical signal. Such a photoreceptive amplifier circuit may be realized, for example, with a photoreceptive amplifier circuit for amplifying and outputting a signal from a photoreceptor on which optical signals of plural types of wavelength, such as a wavelength of 780 nm for a CD-R/RW dick, or a wavelength of 650 nm for DVD±R/RW disk, are incident, by providing the same number of feedback resistors (gain resistance) as that of types of wavelength in the former-stage amplifier to which the signal from the photoreceptor is supplied, and also providing the same number of amplifiers made up of resistors for determining sensitivity (such as input resistor or feedback resistors) as that of types of wavelength.

Therefore, by using resistive elements with appropriate temperature characteristics for the target wavelength, it is possible to cancel the temperature characteristic of the photoreceptor by the temperature characteristic of the sensitivity of the photoreceptive amplifier circuit, even when the temperature characteristic changes depending on the wavelength.

Further, the photoreceptive amplifier circuit according to the present embodiment is arranged so that the latter-stage amplifiers are provided at a second-stage corresponding to the respective types of wavelengths, so as to operate as differential amplifiers for simultaneously receiving output of the former-stage amplifier and supplying outputs of the photoreceptive amplifier circuit, the differential amplifiers including the resistors for determining sensitivity made up of input resistors and feedback resistors, which differ to each other in temperature characteristics, the differential amplifiers being switched so as to select one of the resistive elements.

With the foregoing arrangement, it is possible to selectively use such resistive elements having different temperature characteristics, by switching the second-stage differential amplifiers which supply output.

Further, the photoreceptive amplifier circuit according to the present embodiment preferably further includes a reference amplifier at a same stage as the former-stage amplifier, the reference amplifier having a same structure as that of the former-stage amplifier but not connected to the photoreceptor, the differential amplifiers individually calculating difference between the former-stage amplifier and the reference amplifier.

With the foregoing arrangement, it is possible to obtain only the signal component from the optical input to the photoreceptor.

The photoreceptive amplifier circuit according to the present embodiment is preferably arranged so that the latter-stage amplifiers are provided at a second-stage corresponding to the respective types of wavelengths, so as to operate as differential amplifiers for simultaneously receiving output of the former-stage amplifier and supplying outputs of the photoreceptive amplifier circuit, the differential amplifiers including the resistors for determining sensitivity made up of dividing resistors for dividing output in accordance with a reference voltage which is specified in advance, the dividing resistors having different temperature characteristics in the respective differential amplifiers, the differential amplifiers being switched so as to select one of the resistive elements.

With the foregoing arrangement, it is possible to selectively use such resistive elements having different temperature characteristics, by switching the second-stage differential amplifiers which supply output.

Further, the photoreceptive amplifier circuit according to the present embodiment is preferably arranged so that the optical signals have two kinds of wavelengths, the differential amplifiers are provided as two differential amplifiers, each of which includes a pair of transistors constituting a differential pair and constant-current sources for supplying current to the differential pair, the two differential amplifiers further including a single common output transistor, one of the constant-current sources becomes active with a corresponding differential amplifier which is selected according to the type of wavelength, while the other constant-current source becomes inactive.

In the foregoing arrangement, the second-stage differential amplifiers are connected to one output terminal, and the differential amplifiers can be selectively used by turning on or off the constant-current sources in accordance with the wavelength, thus appropriately compensating the temperature characteristic of the photoreceptor. Further, with the common output terminal, it is possible to carry out monitoring for optical signal intensity in two wavelengths, with a single chip.

Further, the photoreceptive amplifier circuit according to the present embodiment is preferably further includes a reference amplifier at a same stage as the former-stage amplifier, the reference amplifier having a same structure as that of the former-stage amplifier but not connected to the photoreceptor, wherein: the former-stage amplifier and the reference amplifier respectively include feedback resistors which differ to each other in temperature characteristic, corresponding to the plural types of wavelengths the latter-stage amplifiers are provided at a second-stage corresponding to the respective types of wavelengths, so as to operate as differential amplifiers for simultaneously receiving output of the former-stage amplifier and supplying outputs of the photoreceptive amplifier circuit, the differential amplifiers selecting one of the resistive elements by using a switch, which calculates difference between respective outputs from the former-stage amplifier and the reference amplifier and select one of the feedback resistors in the former-stage in accordance with the difference.

With the foregoing arrangement, it is possible to selectively use such resistive elements having different temperature characteristics, by switching the feedback resistors of the first-stage amplifiers. Further, it is possible to obtain only the signal component from the optical input to the photoreceptor, by providing a reference amplifier.

Further, the photoreceptive amplifier circuit according to the present embodiment is preferably arranged so that the feedback resistor and the resistors for determining sensitivity are respectively made of two different kinds of diffused resistor having different temperature characteristics.

Further, the photoreceptive amplifier circuit according to the present embodiment is preferably arranged so that the feedback resistor and the resistors for determining sensitivity are made of a diffused resistor and a polysilicon resistor which have different temperature characteristics.

Further, the photoreceptive amplifier circuit according to the present embodiment is preferably arranged so that the feedback resistor and the resistors for determining sensitivity are respectively made of two different kinds of polysilicon resistor having different temperature characteristics.

Further, an optical pickup element according to the present embodiment includes the foregoing photoreceptive amplifier circuit.

With the foregoing arrangement, it is possible to cancel the temperature characteristic of the sensitivity of the photoreceptive amplifier circuit, even when the temperature characteristic changes depending on the wavelength, thus securely realizing an optical pickup element with no temperature characteristics.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A photoreceptive amplifier circuit for amplifying and outputting a signal from a photoreceptor on which optical signals of plural types of wavelength are supplied, comprising:
a former-stage amplifier for receiving the signal from the photoreceptor,
a latter-stage amplifier for amplifying output of the first-stage amplifier,
the former-stage amplifier including a feedback resistor and the latter-stage amplifier including resistors for determining sensitivity, the feedback resistor and at least a part of the resistors for determining sensitivity being made of different resistive elements having different temperature characteristics, the resistive elements varying depending on the types of wavelengths of the optical signals.

2. The photoreceptive amplifier circuit as set forth in claim 1, wherein:
the latter-stage amplifiers is provided at a second-stage corresponding to the respective types of wavelengths, so as to operate as a differential amplifier for simultaneously receiving output of the former-stage amplifier and supplying outputs of the photoreceptive amplifier circuit,
the differential amplifiers including the resistors for determining sensitivity made up of input resistors, input voltage dividing resistors, and feedback resistors, which differ to each other in temperature characteristics, the differential amplifiers being switched so as to select one of the resistive elements.

3. The photoreceptive amplifier circuit as set forth in claim 2, further comprising:
a reference amplifier at a same stage as the former-stage amplifier, the reference amplifier having a same structure as that of the former-stage amplifier but not connected to the photoreceptor, the differential amplifiers individually calculating difference between the former-stage amplifier and the reference amplifier.

4. The photoreceptive amplifier circuit as set forth in claim 1, wherein:
the latter-stage amplifiers is provided at a second-stage corresponding to the respective types of wavelengths, so as to operate as a differential amplifier for simultaneously receiving output of the former-stage amplifier and supplying outputs of the photoreceptive amplifier circuit,
the differential amplifiers including the resistors for determining sensitivity made up of dividing resistors for dividing output in accordance with a reference voltage which is specified in advance, the dividing resistors having different temperature characteristics in the respective differential amplifiers, the differential amplifiers being switched so as to select one of the resistive elements.

5. The photoreceptive amplifier circuit as set forth in claim 2, wherein:
the optical signals have two kinds of wavelengths,
the differential amplifiers are provided as two differential amplifiers, each of which includes a pair of transistors constituting a differential pair and constant-current sources for supplying current to the differential pair, the two differential amplifiers further including a single common output transistor,
one of the constant-current sources becomes active with a corresponding differential amplifier which is selected according to the type of wavelength, while the other constant-current source becomes inactive.

6. The photoreceptive amplifier circuit as set forth in claim 3, wherein:
the optical signals have two kinds of wavelengths,
the differential amplifiers are provided as two differential amplifiers, each of which includes a pair of transistors constituting a differential pair and constant-current sources for supplying current to the differential pair, the two differential amplifiers further including a single common output transistor,
one of the constant-current sources becomes active with a corresponding differential amplifier which is selected according to the type of wavelength, while the other constant-current source becomes inactive.

7. The photoreceptive amplifier circuit as set forth in claim 4, wherein:
the optical signals have two kinds of wavelengths,
the differential amplifiers are provided as two differential amplifiers, each of which includes a pair of transistors constituting a differential pair and constant-current sources for supplying current to the differential pair, the two differential amplifiers further including a single common output transistor,
one of the constant-current sources becomes active with a corresponding differential amplifier which is selected according to the type of wavelength, while the other constant-current source becomes inactive.

8. The photoreceptive amplifier circuit as set forth in claim 1, further comprising:
a reference amplifier at a same stage as the former-stage amplifier, the reference amplifier having a same structure as that of the former-stage amplifier but not connected to the photoreceptor,
wherein:
the former-stage amplifier and the reference amplifier respectively include feedback resistors which differ to each other in temperature characteristic, corresponding to the plural types of wavelengths
the latter-stage amplifier is provided at a second-stage, so as to operate as a differential amplifier for receiving output of the former-stage amplifier and supplying outputs of the photoreceptive amplifier circuit,
the former-stage amplifier and the reference amplifier each including a switch for selecting one of the resistive elements, the switch calculating difference between respective outputs from the former-stage amplifier and the reference amplifier so as to select one of the feedback resistors in accordance with the difference.

9. The photoreceptive amplifier circuit as set forth in claim 1, wherein:
the feedback resistor and the resistors for determining sensitivity are respectively made of two different kinds of diffused resistor having different temperature characteristics.

10. The photoreceptive amplifier circuit as set forth in claim 1, wherein:
the feedback resistor and the resistors for determining sensitivity are respectively made of a diffused resistor and a polysilicon resistor which have different temperature characteristics.

11. The photoreceptive amplifier circuit as set forth in claim 1, wherein:
the feedback resistor and the resistors for determining sensitivity are respectively made of two different kinds of polysilicon resistor having different temperature characteristics.

12. An optical pickup element including a photoreceptive amplifier circuit for amplifying and outputting a signal from a photoreceptor on which optical signals of plural types of wavelength are supplied, comprising:
a former-stage amplifier for receiving the signal from the photoreceptor,
a latter-stage amplifier for amplifying output of the first-stage amplifier,
the former-stage amplifier including a feedback resistor and the latter-stage amplifier including resistors for determining sensitivity, the feedback resistor and at least a part of the resistors for determining sensitivity being made of different resistive elements having different temperature characteristics, the resistive elements varying depending on the types of wavelengths of the optical signals.

13. The optical pickup element as set forth in claim 12, wherein:
the latter-stage amplifiers is provided at a second-stage corresponding to the respective types of wavelengths, so as to operate as a differential amplifier for simultaneously receiving output of the former-stage amplifier and supplying outputs of the photoreceptive amplifier circuit,
the differential amplifiers including the resistors for determining sensitivity made up of input resistors and feedback resistors, which differ to each other in temperature characteristics, the differential amplifiers being switched so as to select one of the resistive elements.

14. The optical pickup element as set forth in claim 13, further comprising:
a reference amplifier at a same stage as the former-stage amplifier, the reference amplifier having a same structure as that of the former-stage amplifier but not connected to the photoreceptor, the differential amplifiers individually calculating difference between the former-stage amplifier and the reference amplifier.

15. The optical pickup element as set forth in claim 12, wherein:
the latter-stage amplifiers is provided at a second-stage corresponding to the respective types of wavelengths, so as to operate as a differential amplifier for simultaneously receiving output of the former-stage amplifier and supplying outputs of the photoreceptive amplifier circuit,
the differential amplifiers including the resistors for determining sensitivity made up of dividing resistors for dividing output in accordance with a reference voltage which is specified in advance, the dividing resistors having different temperature characteristics in the respective differential amplifiers, the differential amplifiers being switched so as to select one of the resistive elements.

16. The optical pickup element as set forth in claim 13, wherein:
the optical signals have two kinds of wavelengths,
the differential amplifiers are provided as two differential amplifiers, each of which includes a pair of transistors constituting a differential pair and constant-current sources for supplying current to the differential pair, the two differential amplifiers further including a single common output transistor,
one of the constant-current sources becomes active with a corresponding differential amplifier which is selected according to the type of wavelength, while the other constant-current source becomes inactive.

17. The optical pickup element as set forth in claim 14, wherein:
the optical signals have two kinds of wavelengths,
the differential amplifiers are provided as two differential amplifiers, each of which includes a pair of transistors constituting a differential pair and constant-current sources for supplying current to the differential pair, the two differential amplifiers further including a single common output transistor,
one of the constant-current sources becomes active with a corresponding differential amplifier which is selected according to the type of wavelength, while the other constant-current source becomes inactive.

18. The photoreceptive amplifier circuit as set forth in claim 15, wherein:
the optical signals have two kinds of wavelengths,
the differential amplifiers are provided as two differential amplifiers, each of which includes a pair of transistors constituting a differential pair and constant-current sources for supplying current to the differential pair, the two differential amplifiers further including a single common output transistor,
one of the constant-current sources becomes active with a corresponding differential amplifier which is selected according to the type of wavelength, while the other constant-current source becomes inactive.

19. The optical pickup element as set forth in claim 12, further comprising:
a reference amplifier at a same stage as the former-stage amplifier, the reference amplifier having a same structure as that of the former-stage amplifier but not connected to the photoreceptor,
wherein:
the former-stage amplifier and the reference amplifier respectively include feedback resistors which differ to each other in temperature characteristic, corresponding to the plural types of wavelengths
the latter-stage amplifier is provided at a second-stage, so as to operate as a differential amplifier for receiving output of the former-stage amplifier and supplying outputs of the photoreceptive amplifier circuit,
the differential amplifiers selecting one of the resistive elements by using a switch, which calculates difference between respective outputs from the former-stage amplifier and the reference amplifier and select one of the feedback resistors in the former-stage in accordance with the difference.

20. The optical pickup element as set forth in claim 12, wherein:
the feedback resistor and the resistors for determining sensitivity are respectively made of two different kinds of diffused resistor having different temperature characteristics.

21. The optical pickup element as set forth in claim 12, wherein:
the feedback resistor and the resistors for determining sensitivity are made of a diffused resistor and a polysilicon resistor which have different temperature characteristics.

22. The optical pickup element as set forth in claim 12, wherein:
the feedback resistor and the resistors for determining sensitivity are respectively made of two different kinds of polysilicon resistor having different temperature characteristics.
